(19) United States
(12) Patent Application Publication
(10) Pub. No.: US 2026/0193410 A1
(43) Pub. Date: Jul. 9, 2026

(54) METHOD FOR MANUFACTURING FILLER-CONTAINING COMPOSITIONS WITH A SPECIFIC CURING REGIMEN

(71) Applicant: PLANTICS HOLDING B.V., ARNHEM (NL)

(72) Inventors: Wridzer Jan Willem BAKKER, ARNHEM (NL); Nikolina PERVAN, ARNHEM (NL); Joost Jeroen PREESMAN, ARNHEM (NL); Geert Jan NOORDZIJ, ARNHEM (NL); Kwinten Paulus SNIJDERS BLOK, ARNHEM (NL)

(21) Appl. No.: 18/868,083

(22) PCT Filed: May 25, 2023
(86) PCT No.: PCT/EP2023/064122

§ 371 Date: Nov. 22, 2024

(30) Foreign Application Priority Data
May 25, 2022 (EP) 22175473.2

(51) Int. Cl. C08G 63/20; B27N 3/00; B27N 3/02; B27N 3/04; C08J 5/24; C08L 97/02

(52) U.S. Cl. CPC C08G 63/20; B27N 3/002; B27N 3/007; B27N 3/02; B27N 3/04; C08J 5/245; C08L 97/02; C08J 2367/04

(57) ABSTRACT

A method for manufacturing a filler-containing composite object, comprising the steps of providing a composition including a filler and a polymer, wherein the polymer is a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react of 0.1-0.8, and subjecting the composition to a curing step with high-frequency heating for a period of 10 seconds to 30 minutes, at a pressure of at most 1·10⁶ Pa (10 bar), resulting in the formation of a composite object.

The invention pertains to a method for manufacturing compositions comprising a filler and a specific polyester, in particular a biobased polyester.

WO 2012/140237 describes the manufacture of a composite material comprising 10-98 wt. % of a bio-based particulate or fibrous filler and at least 2 wt. % of a biobased polyester, wherein the method comprises combining the filler and the polyester (or a precursor thereof), and subjecting the combination to a curing step under pressure for 12 hours at 120° C., under a pressure of at least 1.10⁶ Pa (10 bar). The polyester is the reaction product of an aliphatic polyalcohol with 2-15 carbon atoms, preferably glycerol, and an aliphatic polyacid with 3-15 carbon atoms, in particular a triacid such as citric acid.

WO2012/140239 describes the manufacture of a composite material comprising a synthetic filler, e.g. a glass fiber filler, using the same polyester as is used in 2012/140237. In the examples curing takes place for, e.g., 12 hours.

When seeking commercial exploitation of filler-containing composites using the specified polyester, it has been found that high temperatures, high pressures and prolonged curing times are required to obtain materials with a desirable high density and an extent of polymerisation which is such that a product with good stability is obtained. Prolonged curing at relatively high temperature and pressure is associated with relatively high cost.

There is need in the art for a manufacturing method for compositions based on the specified polyester which solves these problems. The present invention provides such a manufacturing method.

The present invention therefore pertains to a method for manufacturing a filler-containing composite object, comprising the steps of
providing a composition comprising a filler and a polymer, wherein the polymer is a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, in the range of 0.1-0.8, and
subjecting the composition to a curing step, in which the composition is subjected to high-frequency heating for a period of 10 seconds to 30 minutes, at a pressure of at most 1.10⁶ Pa (10 bar), resulting in the formation of a composite object.

Surprisingly it has been found that a manufacturing method comprising the specific curing regimen in combination with the specific polymer used herein gives particularly attractive results. In particular, a fast heating rate is observed, which allows reduction of the curing time. Additionally, a homogeneous heating profile is obtained, surprisingly also when relatively thick objects are manufactured. Finally, and this is particularly surprising, it has been found that the curing pressure can be reduced while still obtaining objects with an attractive high density and good shape stability. This allows the manufacture of filler-containing composites in a cost-effective manner.

Not wishing to be bound by theory, it is believed that the advantageous effects of the present invention may partly be associated with the nature of the monomers, in particular where monomers are used with a relatively low number of carbon atoms as compared to the number of oxygen-containing reactive groups. This applies, e.g., where the aliphatic polyol comprises substantial amounts of polyol with at least 3 hydroxyl groups and the aliphatic polycarboxylic acid comprises substantial amounts of tricarboxylic acid.

The present invention will be discussed in more detail below.

In the process of the present invention, a curing step is carried out in which a composition comprising a filler and a specific polyester with an extent of polymerization in the range of 0.1-0.8 is subjected to high-frequency heating for a period of 10 seconds to 30 minutes.

Within the context of the present investigation, high-frequency heating, also indicated as HF heating herein, is subjecting an object to an alternating electromagnetic field with a frequency in the range of 3-100 MHz, in particular 10-50 MHz. Frequencies used for industrial purposes are 13.56 MHz, 27.12 MHz, and 40.68 MHz, with 27.12 MHz being used in particular.

The energy provided to the curing step depends on the field strength of the electromagnetic field. The desired energy input depends on the size of the object to be cured and on the nature of the apparatus. A value in the range of 1000 to 20.000 V may be mentioned as a general guideline, but it is within the scope of the skilled person to select a suitable voltage.

Depending on the size and shape of the object to be cured and the power provided, the HF heating step may be carried out for a period of 10 seconds to 30 minutes. Periods below 10 seconds are generally insufficient to achieve the desired temperature in the core of the object. Periods above 30 minutes are generally not required. It may be preferred for the heating to be carried out for a period of 10 seconds to 20 minutes, in particular 20 seconds to 10 minutes, more in particular 20 seconds to 5 minutes, or even 20 seconds to 3 minutes. Curing can be done in a single step, or in multiple steps. In one embodiment, two curing steps are carried out. If so desired, the object to be cured can be machined between the two curing steps, wherein machining may include any step in which the shape or surface properties of the object are changed. In general, however, a single curing step will be sufficient.

Suitable apparatus for carrying out the hf heating is commercially available.

The curing step can be carried out at a pressure of up to 1.10⁶ Pa (10 bar). In general, however, such high pressures are not required. The pressure may be at most 8·10⁵ Pa (8 bar), in particular at most 6·10⁵ Pa (6 bar), or at most 4·10⁵ Pa (4 bar), in some embodiments at most 3 10⁵ Pa (3 bar). As a minimum level 1.1·10⁵ Pa (1.1 bar), in particular 1.5·10⁵ Pa (1.5 bar) may be mentioned.

It may be attractive to carry out the curing step in two or more steps, with the pressure in the first curing step being lower than the pressure in the second curing step. In this case the first curing step may primarily be a heating step, resulting in a softening of the polymer. A softer polymer can show better flow under pressure. This allows redistribution of the polymer in the heating step under pressure, resulting in a composite with better properties.

It may be attractive for the parts of the HF heating apparatus which are in contact with the composition to be cured to be heatable or insulated, to prevent leakage of heat generated by the RF heating to the environment.

### The Polymer

The polymer used in the present invention is a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, in the range of 0.1-0.8.

Suitable polyol monomers for use in the present invention include aliphatic polyalcohols with 2-15 carbon atoms. The aliphatic polyalcohol does not comprise any aromatic moieties, nitrogen atoms or sulphur atoms. In some embodiments, the aliphatic polyalcohol consists of carbon, oxygen and hydrogen atoms. The aliphatic polyalcohol comprises at least two hydroxyl groups, preferably at least three hydroxyl groups. In general, the number of hydroxyl groups will be 10 or fewer, preferably 8 or fewer, more preferably 6 or fewer. The aliphatic polyalcohol has 2 to 15 carbon atoms, preferably 3 to 10 carbon atoms. Examples of suitable aliphatic polyalcohols are 1,2-propane diol, 1,3-propane diol, 1,2-ethane diol, 1,4-butanene diol, glycerol, sorbitol, xylitol, and mannitol. Glycerol, sorbitol, xylitol, and mannitol are preferred examples of suitable aliphatic polyalcohols. Glycerol is the most preferred example of a suitable aliphatic polyalcohol. One reason for this is that glycerol has a melting point of 20° C., which allows easy processing (compared to, e.g., xylitol, sorbitol, and mannitol, which all have melting points above 90° C.). Moreover, glycerol is easily accessible and results in polymers having desirable properties. Accordingly, in some embodiments, the aliphatic polyalcohol consists essentially of glycerol. As used herein, “consists essentially of” means that other components (here: other aliphatic polyalcohols) may be present in amounts that do not detrimentally affect the properties of the material.

The aliphatic polyol may comprise at least 30 wt. % of polyol with at least 3 hydroxyl groups, in particular at least 50 wt. %, more preferably at least 70 wt. %, still more preferably at least 90 wt. %, most preferably 95 wt. %. In some embodiments, the aliphatic polyol consists essentially of polyol with at least 3 hydroxyl groups.

Mixtures of different aliphatic polyalcohols may also be used. The aliphatic polyalcohol may comprise at least 50 mol % of glycerol, sorbitol, xylitol, or mannitol, preferably at least 70 mol %, preferably at least 90 mol %. Preferably, the balance is an aliphatic polyalcohol having 3 to 10 carbon atoms. The polyalcohol preferably comprises at least 70 mol % of glycerol, preferably at least 90 mol %, more preferably at least 95 mol %.

In some embodiments, the aliphatic polyalcohol has a ratio of hydroxyl groups over the number of carbon atoms from 1:4 (i.e., one hydroxyl group per four carbon atoms) to 1:1 (i.e., one hydroxyl group per carbon atom). It is preferable for the ratio of hydroxyl groups over the number of carbon atoms to be from 1:3 to 1:1, more preferably from 1:2 to 1:1, still more preferably from 1:1.5 to 1:1. Compounds wherein the ratio of hydroxyl groups to carbon atoms is 1:1 are considered especially preferred.

Suitable polycarboxylic acid monomers for use in the present invention include aliphatic polycarboxylic acids with 3 to 15 carbon atoms, preferably 3 to 10 carbon atoms, in some embodiments 3 to 6 carbon atoms. The aliphatic polycarboxylic acid does not comprise aromatic moieties, or any nitrogen or sulphur atoms. In some embodiments, the aliphatic polycarboxylic acid consists of carbon, oxygen and hydrogen atoms. The aliphatic polycarboxylic acid comprises at least two carboxylic acid groups, preferably three carboxylic acid groups. In general, the number of carboxylic acid groups will be 10 or fewer, preferably 8 or fewer, more preferably 6 or fewer.

In one embodiment the aliphatic polycarboxylic acid comprises at least 10 wt. % of tricarboxylic acid, calculated on the total amount of aliphatic polycarboxylic acid. The aliphatic polycarboxylic acid may comprise at least 30 wt. % of tricarboxylic acid, calculated on the total amount of acid, preferably at least 50 wt. %, more preferably at least 70 wt. %, still more preferably at least 90 wt. %, most preferably 95 wt. %. In some embodiments, the aliphatic polycarboxylic acid consists essentially of tricarboxylic acid, preferably essentially of citric acid.

The aliphatic polycarboxylic acid may be a mixture of acids, such as a mixture of tricarboxylic acid(s) and dicarboxylic acid(s). In some embodiments, the aliphatic polycarboxylic acid comprises a combination of at least 2 wt. %, preferably at least 5 wt. %, more preferably at least 10 wt. % dicarboxylic acid, and at least 10 wt. %, preferably at least 30 wt. %, more preferably at least 70 wt. %, still more preferably at least 90 wt. %, most preferably at least 95 wt. % tricarboxylic acid, calculated on the total amount of aliphatic polycarboxylic acid.

The dicarboxylic acid, if used, may be any dicarboxylic acid which has two carboxylic acid groups and, in general, at most 15 carbon atoms. Examples of suitable dicarboxylic acids include itaconic acid, malic acid, succinic acid, glutaric acid, adipic acid, sebacic acid, oxalic acid, maleic acid, fumaric acid, muconic acid, suberic acid, and azelaic acid. Itaconic acid and succinic acid may be preferred. In one embodiment a tricarboxylic acid is used. The tricarboxylic acid, if used, may be any tricarboxylic acid which has three carboxylic acid groups and, in general, at most 15 carbon atoms. Examples include citric acid, isocitric acid, aconitic acid (both cis and trans), and 3-carboxy-cis, cis-muconic acid. The use of citric acid is considered preferred, both for reasons of costs and of availability. Where applicable, acids may also be provided in the form of their anhydrides, e.g. citric acid anhydride.

In one embodiment, the polymer is a polyester derived from an aliphatic polyol with 2-15 carbon atoms and an aliphatic polycarboxylic acid with 3 to 15 carbon atoms, wherein the aliphatic polyol comprises at least 30 wt. % of polyol with at least 3 hydroxyl groups, in particular at least 50 wt. %, more preferably at least 70 wt. %, still more preferably at least 90 wt. %, most preferably 95 wt. %, the aliphatic polyol with at least 3 hydroxyl groups preferably being glycerol, and the aliphatic polycarboxylic acid comprises at least 30 wt. % of tricarboxylic acid, calculated on the total amount of acid, preferably at least 50 wt. %, more preferably at least 70 wt. %, still more preferably at least 90 wt. %, most preferably 95 wt. %, the tricarboxylic acid preferably being citric acid.

In one embodiment of the present invention the polymer is derived from a combination of polyol monomers and polycarboxylic acid monomers, the polyol monomers preferably being selected from aliphatic polyols with 2-15 carbon atoms with at least three hydroxygroups, e.g., glycerol, sorbitol, xylitol, and mannitol, in particular glycerol,
the polycarboxylic acid monomers being selected from aliphatic polycarboxylic acids with 3-15 carbon atoms with at least three carboxylic acid groups, e.g., citric acid, isocitric acid, aconitic acid (both cis and trans), and 3-carboxy-cis, cis-muconic acid, in particular citric acid.

The polymer with an extent of polymerization in the range of 0.1-0.8 is obtained by polymerisation of a combination of polyol monomers and polycarboxylic acid monomers. The polymerisation can be carried out by combining the monomers to form a liquid phase. Depending on the nature of the compounds this can be done, e.g., by heating a mixture of components to a temperature where the acid will dissolve in the alcohol, in particular in glycerol. Depending on the nature of the compounds this may be, e.g., at a temperature in the range of 20-250° C., e.g., 40-200° C., e.g. 60-200° C., or 90-200° C. In one embodiment, the mixture may be heated and mixed for a period of 1 minute to 2 hours, more specifically 5 minutes to 45 minutes, at a temperature of 80-200° C., in particular 100-200° C., in some embodiments 120-180° C.. If so desired a suitable solvent, e.g., water may be present. Preferably the amount of water will be kept limited as its evaporation is energy-consuming. It may be preferred to add at most 30 wt. % water, in particular at most 20 wt. % water.

Optionally a suitable catalyst can be used for the preparation of the polyester. Suitable catalysts for the manufacture of polyester are known in the art. Preferred catalysts are those that do not contain heavy metals. Useful catalysts are strong acids like, but not limited to, hydrochloric acid, hydroiodic acid (also indicated as hydriodic acid) and hydrobromic acid, sulfuric acid (H2SO4), nitric acid (HNO3), chloric acid (HClO3), boric acid, sodium hypophosphite, perchloric acid (HClO4) trifluoroacetic acid, p-toluenesulphonic acid, sulfonic acid, and trifluoromethanesulfonic acid. Catalysts such as Ti-butoxide, Sn-octanoate, Zn-acetate and Mn-acetate can also be used, although they may be less preferred.

The polymer used as starting material in the present invention has an extent of polymerisation between 0.1 and 0.8. In the context of the present specification the extent of polymerization is the ratio of the fraction of functional groups that have reacted to the maximum of those functional groups that can react. The extent of polymerization can be determined by way of the acid value (in particular for values below 0.5) or gravimetrically (in particular for values above 0.5).

It will be evident that, in order to determine the extent of polymerization of a polymer derived from an aliphatic polyol and an aliphatic polycarboxylic acid with an unknown extent of polymerization using gravimetric analysis, a sample of the polymer with an unknown extent of polymerization is cured at a temperature from 100 to 220° C. until no more water is lost. The extent of polymerization of the polymer is then 1, allowing one to calculate back the extent of polymerization of the sampled polymer using the water lost during the curing. As will be evident to the skilled person, determining the extent of polymerization by way of acid value titration with e.g. KOH can be done in the following way. A certain amount of polymer is dissolved in a solvent, after which by titration with e.g. a KOH the acid value can be determined. By comparing the measured acid value with the theoretical acid value of the amount of polymer dissolved, the conversion can be calculated. Depending on the information available the extent of polymerization can be also be determined by comparing the acid value of the reaction mixture to the theoretical acid value of the total of the monomers.

As will be evident to the skilled person, the extent of polymerisation can also be determined through the Ester Value (EV). This method is suitable for both liquid and non-liquid samples. Here an amount of polymer is hydrolyzed with e.g. KOH. With back-titration the uptake of KOH can be measured, which gives the ester value. By comparing the measured ester value with the theoretical ester value of the amount of polymer the conversion can be calculated. The desired extent of polymerization of the composition provided to the curing step will depend on a number of factors. In particular, a higher extent of polymerisation at this stage of the process has the advantage that less curing further on in the process is required. On the other hand, a higher extent of polymerization may make for difficult shaping of the object to be provided to the curing step. This will be discussed in more detail below. It may be preferred for the extent of polymerization of the polymer of the composition provided to the curing to be at least 0.2, in particular at least 0.3, in particular at least 0.4, more in particular at least 0.5. It may be preferred for it to be at most 0.7.

It is preferred for the composition provided to the curing step to have a water content of at least 2 wt. %, in particular at least 4 wt. %. This is because water improves the effectiveness of the RF heating. During the curing step, water will be produced by the polymerisation reaction. The presence of this water will make the HF heating more effective, therewith increasing the reaction rate of the polymerisation reaction. Therefore, a limited amount of water will generally suffice. Accordingly, it is preferred for the composition provided to the curing step to have a water content of at most 50 wt. %, in particular at most 20 wt. %, in particular at most 15 wt. %, more in particular at most 11 wt. %. The water content may be determined gravimetrically by comparing the weight of the composition to the weight of the same composition after all water has been removed by drying. As will be evident to the skilled person, drying should take place under such conditions that polymerisation is prevented.

As will be evident to the skilled person, the polyester as specified above can be the only polymer present in the composition. The presence of further polymers is not intended, desired, or required. Nevertheless, if so desired, the composition may contain further polymers in amounts of up to 20 wt. %, preferably up to 15 wt. %, more preferably up to 10 wt. %, in particular up to 5 wt. %, specifically up to 2 wt. %.

The polymer used in the present invention is a polyester derived from an aliphatic polyol with 2-15 carbon atoms and an aliphatic polycarboxylic acid with 3 to 15 carbon atoms. The presence of further monomers is not intended, desired, nor required. Nevertheless, if so desired, the polymer may contain further monomers in amounts of up to 15 mole %, preferably up to 10 mole %, more in particular up to 5 mole %, specifically up to 2 mole %.

### The Filler

As indicated above, the composition subjected to a curing step comprises a filler. Various types of fillers may be envisaged. In general, particulate, fibrous, and/or layered fillers may be used, of natural or synthetic origin. Combinations of various filler materials may be used. Fillers may be present in an amount of 10-95 wt. %, in particular in an amount of 20-80 wt. %, more in particular 40-70 wt. %, calculated on the total weight of the composite object.

Examples of suitable fillers are particulate materials. Within the context of the present specification, particulate materials are materials with an aspect ratio in the range of 10:1 to 1:1, preferably in the range of 8:1 to 1:1, more preferably in the range of 6:1 to 11:1. As used herein, “aspect ratio” is defined as the length of the particle, determined along its longest axis, over the largest diameter of the particle, determined along the axis that is perpendicular to the longest axis.

The particulate material in the core layer may have a maximum length, determined along the longest axis of the particles in the material, of less than 20 mm, more preferably at most 15 mm, more preferably at most 10 mm, in particular at most 5 mm, in particular at most 2 mm. As a minimum value, an average length of the particles of 0.001 mm may be mentioned. In some embodiments, the average length of the particles is at least 0.05 mm, in particular at least 0.1 mm, more in particular at least 0.5 mm. In some embodiments, the average length of the particles is in the range of 0.5-5 mm, in particular 0.5-2 mm.

Suitable particulate material may, e.g., be in the form of powder, dust, pulp, broken fibers, flakes, or chips. Examples include wood chips, wood flakes, sawdust, hemp shives, (dried) grass, and pulp, e.g., pulp of (recycled) paper or other fiber pulp from sugar beets, fruits and vegetables, etc. Examples of plant-derived material that may be used as particulate material are cotton, flax, hemp, grass, reed, bamboo, coconut, miscanthus, coffee grounds, seed shells, e.g., from rice, burlap, kenaf, ramie, sisal, etc. and materials derived therefrom. In general plant material which has been comminuted to a suitable particle size, and where necessary dried to a suitable water content may be used.

The particulate material may comprise a natural material such as a material derived from plants or animals. Examples of plant-based materials include cellulose-based material such as fresh or used paper, fresh or used cardboard, wood or other plant material in any form, and combinations thereof. Cellulose-based materials may be derived from so-called virgin pulp which is obtained directly from the wood pulping process. This pulp can come from any plant material, but is mostly obtained from wood. Wood pulp comes from softwood trees such as spruce, pine, fir, larch, and hemlock and hardwood trees such as eucalyptus, popular, aspen, and birch. Additionally or alternatively, the cellulose-based material may comprise cellulose material derived from recycled paper, such as cellulose pulp obtained from regenerated books, papers, newspapers and periodicals, egg cartons, and other recycled paper or cardboard products. Combinations of cellulose sources may also be used. Other attractive sources of cellulose-based material are reject paper fiber, which is paper fiber that is too short to be suitable for use in the manufacture of paper, and any (mechanically and/or chemically) recycled material from any (composite) material, e.g. recycled furniture made from cellulose-based materials. In particular, (composite) materials made with the polymer mentioned here as a binder are attractive sources of the cellulose-based material. Use of these (recycled) materials is highly sustainable and low cost, allowing wide-spread use in, for example, furniture manufacturing.

Examples of animal-derived materials include feathers, down, hair and derivatives thereof such as wool, but also bone meal.

Further examples of suitable particulate materials include ceramic materials, including oxides, e.g. alumina, beryllia, ceria, zirconia, silica, titania, and mixtures and combinations thereof, and non-oxides such as carbide, boride, nitride, silicide, and mixtures and combinations thereof such as silicium carbide. For the purposes of the present specification glass is considered a ceramic material. Glass may, e.g., be used in the form of short fibers, glass beads, whether solid or hollow, and ground glass particles. Suitable particulate materials further include materials like micaceous fillers, calcium carbonate, and minerals such as phyllosilicates. Clay, sand, talcum, gypsum, etc may also be used.

Suitable particulate materials also include polymer fillers, such as particles or short fibers of polyethylene, polypropylene, polystyrene, polyesters such as polyethylene terephthalate, polyvinylchloride, polyamide (e.g., nylon-6, nylon 6.6 etc.), polyacrylamide, and arylamide polymers such as aramid. Suitable particulate materials also include carbon fibers and carbon particulate materials. Comminuted cured polyester resin as used in the present invention may also be used as particulate material. Comminuted cured polyester resin containing a filler may also be used. The addition of carbon particulate materials may be attractive to improve the RF heating characteristics of the object. Therefore, in one embodiment, a filler is used comprising at least 0.1 wt. % of carbon particulate materials, calculated on the total amount of filler used. Depending on the composition aimed for, a combination of fillers may be used, which contains 0.1-10 wt. %, of carbon particulate material, calculated on the total amount of filler, specifically 0.1-5 w. %, e.g., 0.1-2 wt. %. In some embodiments, particulate materials are used containing one or more organic particulate materials, e.g. selected from the group consisting of shives, wood dust, wood chips, and recycled paper. In other embodiments, the particulate material (also) contains one or more inorganic particulate materials, e.g. selected from the group consisting of (recycled) glass, stone, ceramic, minerals, and metals.

Suitable fillers also encompass fibrous materials. With the context of the present specification fibrous materials are materials with an aspect ratio of more than 10:1. Within the context of the present specification, the word “fiber” refers to monofilaments, multifilament yarns, threads, tapes, strips, and other elongate objects having a regular or irregular cross-section and a length substantially longer than the width and thickness. Suitable fibrous material may, e.g., have a fiber length, determined over its longest axis, of at least 1 cm, preferably at least 3 cm, preferably at least 4 cm. For example, the fibrous material may have a fiber length, determined over its longest axis, of 1-20 cm. Preferably, the fibrous material has a fiber length of 1-10 cm. Long(er) fibers are preferred, because these provide strength to the composition.

The fibrous material may contain fibers having a diameter from 0.001 to 10 mm, preferably from 0.01 to 1 mm, more preferably from 10 to 500 um. Thinner fibers are advantageous for many applications, as their use results in a smooth surface of object. the panel. Smooth surfaces are, of course, desirable when manufacturing, e.g., kitchen cupboards.

The fibers may, e.g., have an aspect ratio in the range of 20:1 to 200,000:1, preferably in the range of 200:1 to 20,000:1, more preferably in the range of 250:1 to 5000:1. The use of fibers with a relatively large aspect ratio makes for a combination of high strength and a smooth surface.

Fibers which may be used as fillers in the present invention may be oriented in a random (e.g., a non-woven sheet) or a non-random manner. The fibrous material is preferably non-woven sheet.

In the context of the present specification “oriented in a non-random manner” refers to all structures wherein fibers are oriented with respect to each other in an essentially regular manner. Examples of layers containing fibers oriented in a non-random manner include woven layers, knitted layers, layers wherein the fibers are oriented in parallel, and any other layers wherein fibers are connected to each other in a repeating patters.

Fiber orientation in the fibrous material may, for example, affect the strength of the end-product. Therefore, in some cases, it may be preferred to orientate the fibers in a manner that maximises the strength of the article. In some embodiments, at least 50% of the fibers are oriented in parallel, preferably at least 60% of the fibers are oriented in parallel, more preferably at least 70% of the fibers are oriented in parallel. In other cases, more aniso-tropic properties or bi-directional resistance may be required.

The fibrous material that may be used in the present invention may comprise plant-derived fibers, preferably cellulosic and/or lignocellulosic fibers. The fibrous material may also consist essentially of plant-derived fibers. Examples of fibers based on plant-derived fibers include flax, hemp, kenaf, jute, ramie, sisal, coconut, bamboo, and cotton. The fibrous material may also comprise an animal-derived fiber. The animal-derived fiber may be wool, hair, silk, and fibers derived from feathers (e.g., chicken feathers). Other parts of offal may also be used. The fibrous material may comprise synthethic fibers. Examples of suitable synthetic fibers are fibers derived from viscose, glass, polyesters, carbon, aramids, nylons, acrylics, poly-olefins and the like. The fibrous material may also be a mixture of fibers of different origin, such as a mixture of plant-derived fibers and synthetic fibers.

It is preferred for fibrous material used in the present invention to comprise plant-derived fibers, preferably cellulosic and/or lignocellulosic fibers, it may be particularly preferred for the fibrous material to consist essentially of plant-derived fibers. As indicated above, examples of fibers based on plant-derived fibers include flax, hemp, kenaf, jute, ramie, sisal, coconut, bamboo, and cotton, wherein hemp may be particularly attractive.

Within the context of the present specification, a composition a filler and a polymer also encompasses compositions in which the filler is provided in the form of thin layers stacked alternating with layers of polymer. Suitable layered materials generally comprise at least 2, in particular at least 4, up to 50, in particular up to 20 filler layers. The individual filler layers generally have a thickness of 0.1-10 mm, in particular 0.1-5 mm, more in particular 0.2-2 mm. The total thickness of the object may, e.g., be 0.5-200 mm. The polymer layers may have a thickness of, e.g., 10-4000 micron, in particular 10-2000 micron, more in particular 10-500 micron. Suitable fillers may, e.g., by wood (also indicated as wood veneer). Plywood is an example of this embodiment. Other layered fillers such as paper or cardboard may also be applied.

As will be understood by the skilled person, combinations of different types and materials may also be used as fillers.

In one embodiment, the composite object comprises particulate filler and polymer, in particular 10-95 wt. %, in particular in an amount of 20-80 wt. %, more in particular 40-70 wt. %, of particulate filler, calculated on the total composite.

In another embodiment, the composite object comprises fibrous filler and polymer, in particular 10-95 wt. %, in particular in an amount of 20-80 wt. %, more in particular 40-70 wt. %, of fibrous filler, calculated on the total composite.

In addition to the polymer and filler, the composition may contain further components such as colorants and stabilisers, generally in minor amounts. Suitable further components will be evident to the skilled person.

In one embodiment, the composition comprising polymer and filler further comprises an inorganic salt. The presence of an inorganic salt has been found to increase the effectiveness of the heating process used herein.

The salt, if used, is generally present in an amount of at most 10 wt. %, calculated on the amount of the polymer. It may be preferred for the inorganic salt to be present in an amount of at most 5 wt. %, in particular at most 2 wt. %, more in particular at most 1 wt. %. The upper limit is governed by the a number of considerations. Too much salt may affect the properties of the composite object formed, including its recyclability, while not bringing additional benefit. If salt is added, a minimum value may be at least 0.01 wt. %, calculated on the amount of the polymer, in particular at least 0.05 wt. %, more in particular at least 0.1 wt. %. If too little salt is added, the effect aimed for of increasing the effectiveness of the heating process will not be obtained.

The nature of the inorganic salt is not critical to the present invention, and it is within the scope of the skilled person to select a suitable salt. Examples include inorganic salts of alkaline metals (e.g., K, Na), or alkaline earth metals (e.g., Ca, Mg), and ammonium salts. As counterion conventional counterions such as halides (e.g., chloride), nitrate, carbonate, and phosphate may be envisaged. Specific examples include NaCl, KCl, CaCl2, MgCl2, FeCl3, sodium phosphate, and ammonium salts (e.g. ammonium chloride, ammonium nitrate). The salt may be added to the composition in any suitable manner. It can, e.g., be blended with the polymer, or incorporated into the filler, e.g., through impregnation.

By tailoring the manner in which the salt is provided, the distribution of the salt in the composite object before curing may be influenced. The salt may be provided homogeneously through the composite object. It may, however, be attractive to provide salt specifically near the outer surface of the composite object to be cured, where improvement of the curing efficacy me be specifically required. Therefore, in one embodiment, the concentration of salt in the outer 10 vol. % of the composite object is higher than the concentration of salt in the core of the object, the core of the object being defined as innermost 10 vol. % of the object.

One way to provide salt near the surface of the composite object is to provide an impregnated material, e.g., in the form of an impregnated sheet at or near the surface of the composite object before curing. Other manners of providing an inhomogeneous salt distribution in a composite object are also possible. They include, for example, the provision of polymer and salt in the outer layers of the composite object (e.g., 0.1-10 wt. %), while in the core of the composite object polymer containing less or no salt is provided (e.g., 0-5 wt. % and less than in the outer layer).

In one embodiment, the composite object comprises at least two layers which have the same or different compositions.

In one embodiment, the composite object comprises at least two layers with different compositions, in which one layer comprises a fibrous filler while the other layer comprises a particulate filler.

In one embodiment, the composite object is a panel which comprises a core layer and at least one surface layer bonded to the core layer, wherein the core layer comprises particulate material bonded with a polymer and the surface layer comprises fibrous material bonded with a polymer, wherein the ratio of the polymer content (in wt. %) of the core layer to the total polymer content (in wt. %) of the surface layer(s) is in the range of 1:1.5 to 1:15. In this embodiment, a relatively light core layer, which comprises particulate filler and has a relatively low polymer content, is combined with at least one relatively dense surface layer, which has a higher polymer content, and, as a result of the presence of a fibrous filler, good strength and surface properties.

Preferably, the core layer is sandwiched between two surface layers.

In one embodiment, the core layer has a thickness of at least 1.5 mm, in particular at least 2 mm, more in particular at least 4 mm and/or at most 50 cm, in particular at most 20 cm, more in particular at most 10 cm, more in particular at most 5 cm, even more in particular at most 3 cm; and/or the surface layer(s) have a thickness of at least 0.3 mm, in particular at least 0.5 mm, more in particular greater than 1 mm, even more in particular at least 1.1 mm and/or at most 20 mm, more in particular at most 10 mm, even more in particular at most 5 mm, still more in particular less than 5 mm.

Preferably, the ratio of the thickness of the core layer to the total thickness of the surface layer(s) is in the range of 1:1 to 150:1, more preferably in the range of 1:1 to 50:1, more preferably 1:1 to 25:1, more preferably 2:1 to 25:1, more preferably 3:1 to 25:1, more preferably 5:1 to 20:1.

In one embodiment, the composite object is a panel which has a polymer content is in the range of 10-60 wt. %, preferably 15-50 wt. %, more preferably 15-40 wt. %, calculated on the total weight of the panel. The polymer content of the core layer preferably is in the range of 1-40 wt. %, preferably 2-30 wt. %, more preferably in the range of 5-20 wt. %, calculated on the total weight of the particulate material and the polymer. The polymer content of the surface layer(s) preferably is 10-90 wt. %, preferably 20-80 wt. %, more preferably 30-70 wt. %, even more preferably 40-60 wt. %, calculated on the total weight of the fibrous material and the polymer.

Preferably, the ratio of the polymer content (in wt. %) of the core layer to the total polymer content (in wt. %) of the surface layer(s) may be in the range 1:1.5 to 1:10, more in particular 1:2 to 1:8.

In the first step of the method of the invention, a composition is provided comprising a filler and a polyester polymer as discussed above, the polyester having an extent of polymerization, which is the ratio of the fraction of functional groups that have reacted to the maximum of those functional groups that can react, in the range of 0.1-0.8.

There are many ways in which this composition may be provided. In its simplest form, the filler is combined with the polymer when the polymer is in the liquid phase, optionally in the form of an aqueous solution. Depending on the nature of the filler, this can be done by mixing, impregnation, pouring, rolling, or in any other way in which an intimate contact between the filler and the polymer is ensured.

Where the composite object consists of more than one layer, compositions which will make up the various layers may be prepared separately and then combined, followed by curing. It is also possible to prepare the different layers on top of each other.

When the polymer is provided as a liquid, it may have a relatively low extent of polymerization, e.g., between 0.1 and 0.5, and/or the liquid may comprise a relatively large amount of water. Where a relatively large amount of water is present, it may be preferred to subject the composition comprising filler and polymer to a drying step before the curing step under pressure. The drying step may be carried out through HF heating, but other methods may also be envisaged. The drying step is generally intended to remove water, and not necessarily to effect cure (polymerise) the polymer. The drying step may or may not be a HF heating step. Drying by HF heating may be preferred for reasons of efficiency. Where the extent of polymerization of the polymer is relatively low, a pre-curing step may be carried out, whether or not under pressure. The pre-curing step may or may not be a HF heating step. Pre-curing by HF heating may be preferred for reasons of efficiency.

A shaping step may be carried out in the method according to the invention. Within the context of the present specification, a shaping step is any step which brings the composite object in a pre-determined form. Predetermined forms include flat plates, curved plates, and any other desired forms. Examples of suitable shaping steps include pressing between flat or curved surfaces, bending, and shaping using a mould.

The shaping step can be carried out at various points in the method. For example, a shaping step can be combined with the curing step, e.g., by carrying out the curing step on the composition as it is present in a mould or provided on a surface. It is also possible to carry out a shaping step at an earlier stage in the process, e.g., when the polymer is provided in the liquid phase, e.g., by using a mould. Filament winding is an example of this method. Other methods such as free-forming or vacuum moulding may also be envisaged.

After curing, the extent of polymerization will generally be greater than 0.80, preferably greater than 0.90, more preferably at least 0.95, most preferably at least 0.98. Moreover, immediately after curing, the water content of the object is generally below 10 wt. % (calculated on the total weight of the object), preferably below 5 wt. %, in some embodiments below 2 wt. %, or below 1 wt. %. Depending on the storage conditions, the water content of the article may increase after curing.

Preferably, the thickness of the objects obtained by the method is in the range from 0.5 mm to 50 cm, preferably 3 mm to 20 cm, in many embodiments 3 mm to 10 cm, or 3 mm to 5 cm. It has been found that HF heating is particularly advantageous for material which is relatively thick, because, as compared to conventional heating in an oven, the temperature over the cross-section of the article is more homogeneous and the heating of the core of the object can be much faster. Accordingly, in some embodiments, the thickness over the smallest crossection of the object is at least 4 mm, in particular at least 6 mm. In some embodiments, the thickness may be at least 8 mm, or at least 10 mm, or at least 15 mm, or even at least 20 mm.

In some embodiments, the object produced by the method according to the invention has a flexural strength greater than 20 MPa, for example as determined using ASTM D 7264. Depending on the intended use, it may be preferred for the flexural strength to be at least 40 MPa, in particular at least 60 MPa. Values within this range have been obtained using the present invention.

As will be evident to the skilled person, different embodiments of the present invention can be combined unless they are mutually exclusive. All percentages used herein are weight percentages, unless specified otherwise.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The invention is illustrated by the following examples, without being limited thereto or thereby.

### Example 1: Preparation of Solution of Polyester Polymer

Glycerol (1.0 kg, >99% purity) and citric acid (2.0 kg, >99% purity) were combined in a reactor vessel that was stirred and heated. Boric acid (9 g, 0.5 m/m, >99% purity) was added. Within approximately 15 minutes, the mixture was heated to 135° C. and kept at that temperature for 15 minutes. The mixture was then diluted using tap water, after which the water content was 20-50 wt. %, depending on the batch. The mixture was allowed to cool down. The composition prepared here is also indicated as the resin composition.

### Example 2: Manufacture of a Sandwich Panel in a Single-Step Process

### Step 1: Preparation of the Hemp Mats

Two hemp mats (35×35 cm) were cut from a hemp roll (5×1 m, thickness of 10 mm, 1100 g/m2, from Hempflax). Hemp mats were each impregnated with the resin composition obtained in Example 1. The diluted resin composition was poured evenly onto one side of the hemp mats, and equally distributed within the hemp mat with the help of a rolling pin. The impregnation of the resin composition was done at room temperature. After these steps, the total amount of polymer impregnated into the mats was between 48-55 wt. %. The impregnated hemp mats were pre-cured (dried) at 90° C. for 2 hours in an oven. Then, they were allowed to cool down to room temperature.

### Step 2: Preparation of the Core Layer Base

A particulate material was prepared from 900 g of hemp shives. To this particulate material, 150 g of the resin composition of Example 1 was added and the resulting particulate mixture was stirred. The particulate mixture had a polymer content of 10 wt. %.

### Step 3: Forming the Layered Structure

A first hemp mat was placed on a Teflon sheet and square wooden mould (30×30 cm) was placed over it. The particulate mixture was spread out over the first hemp mat (within the mould). The mould was provided with a cover, and pressure was applied manually onto the mould to pre-press loose hemp particles. A mould was removed, and second hemp mat was applied over the particulate mixture as well as the second Teflon sheet to avoid structure sticking to the press plates.

### Step 4: Curing the layered structure to obtain a panel

The loose sandwich structure obtained in step 3 was placed in high frequency press. At that point in time it had a water content of 6-7%. It was pressed for a total of 3-5 minutes at a pressure of 5·10⁵ Pa (5 bar), under HF heating at a power level of 6000 V at a frequency of 27.12 Hz. The pressed panel was cooled for 2 minutes under pressure, and then removed from the press. Temperature reached in the core was 130° C. The so-obtained sandwich panel had a smooth and homogenous surface, as determined by touch and visual inspection.

The panel was then subjected to a post-curing step as follows: The panel was placed in a conventional heating oven, pre-heated at 120° C. and cured at that temperature for 30 minutes, followed by curing at 160° C. for 105 mins. Prolonging the exposure time in the high frequency press should eliminate the post-curing step.

The final panel had a density of 0.65 g/cm 3 density and a thickness of 17 mm. The flexural strength was of the order of 30-40 MPa.

### Example 3: Manufacturing of 4-Layered Hemp Panel

Four hemp mats (45×45 cm) were cut from a hemp roll (15×1 m, thickness of 10 mm, from Hempflax). The hemp mats were impregnated with the resin composition obtained in Example 1, in the manner described in Example 2. After these steps, the total amount of polymer impregnated into the mats was between 48-55 wt %. The impregnated hemp mats were pre-cured (dried) at 90° C. for 2 hours in a conventional oven. Then, they were allowed to cool down to room temperature.

Four layers of impregnated hemp mats were placed on top of each other on a high frequency press plate, the fiber orientation being the same in all mats. Teflon sheets were placed below and above the hemp structure to avoid it sticking to the plates. Pressure of 1.5 10⁵ Pa or 2.8 10⁵ Pa (1.5 or 2.8 bar) was applied to the structure. Then HF heating was carried for 3-4 minutes at 6000 V. Then, the structure was cooled for two minutes. The core temperature of the hemp plates was 125° C.

The so-obtained article had a smooth and homogenous surface and a density in the range of 0.95-1 g/cm3. The cross-section of the panel was homogeneous, and there was no delamination between the layers. The panel had a thickness of 8 mm.

The panel was then subjected to a post-curing step as follows: The panel was placed in an oven, pre-heated at 120° C. and cured at that temperature for 30 minutes, followed by curing at 160° C. for 105 mins. The post-curing step was believed not required, but carried out to ensure comparability with other samples.

The hemp panels from this example and the hemp panels from examples 4 to 6 below all had a flexural strength in the range of 40-80 MPa.

### Example 4: Manufacturing of 4—Layered Hemp Panel—6300 V Energy Input

Example 3 was repeated, except that the power during the HF heating step was 6300 V rather than 6000 V. This led to sample core temperature of 140° C. This example shows that energy input can be used to regulate the core temperature.

The resulting article had a smooth and homogenous surface and a density in the range of 0.95-1 g/cm 3. The cross-section of the panel was homogeneous, and there was no delamination between the layers. The panel had a thickness of 8 mm.

### Example 5: Manufacturing of 4—Layered Hemp Panel—6600 V Energy Input

Example 3 was repeated, except that the power during the HF heating step was 6600 V rather than 6000 V and that curing took place for 2 minutes rather than 3 minutes. The sample core temperature was 140° C., i.e. the same as in Example 4. This example shows that higher energy input can be used to reduce the curing time.

The resulting article had a smooth and homogenous surface and a density in the range of 0.95-1 g/cm3. The cross-section of the panel was homogeneous, and there was no delamination between the layers. The panel had a thickness of 8 mm.

### Example 6: Manufacturing of 8—Layered Hemp Panel

Sample preparation steps were carried out as for Example 3. Instead of four layers, eight layers of impregnated hemp mats were stacked on the top of each other. Pressing was done in two steps at a power level of 6300 V. The first pressing step was carried out at 0.2·10⁵ Pa (0.2 bar) for 1 minute, to preheat the material and soften the polymer. This step helps to ensure a more homogeneous compression during the second pressing step. The core temperature after the first pressing step was not measured to avoid cooling of material. The second pressing was done on the same power level, with pressure of 2·10⁵ Pa to 4·10⁵ Pa (2-4 bar), for 3 minutes. The temperature in the core and surface of the structure was 145-150° C.

The article had a smooth and homogenous surface and a density of 1g/cm3 . The cross-section of the panel was homogeneous, and there was no delamination between the layers. The panel had a thickness of 16 mm.

Post curing step was carried out as in Example 3. The post-curing step was believed not required, but carried out to ensure comparability with other samples.

### Example 7: Manufacturing of Panel From Porous Material Based on Recycled Cardboard.

A 30 cm*30 cm cellulose based (recycled carboard/paper) insulation panel (8×50×120 cm), commercially available from EverUse with a void fraction of 0.92 and a density of 90 grams per liter was used as starting material. It was contacted with the resin composition from Example 1 to obtain a fully impregnated material. The final polymer content was 30 wt. %. The panel was cured in a press for a total of 2 minutes at an estimated pressure below about 5·10⁵ Pa (5 bar), under HF heating at a frequency of 27.12 Hz. After 2 minutes cooling down the internal temperature was 160° C..

The resulting article was a panel with a thickness of 20 mm and a smooth and homogenous surface.

### Example 8: Manufacture of Chipboard

A 30 cm*30 cm chipboard panel was constructed as follows:

Two mixtures of resin composition and birchwood chips were prepared. the mixtures differed in the particle size of the chips. The particulate mixtures had a polymer content of 15 wt. %, calculated on the dry weight of polymer and filler. The particulate mixtures were then dried at 120° C. for 1 hour.

A 30 cm*30 cm wooden mould was filled, sequentially, with three layers: 50% of the mixture with the finer chips, all of the mixture with the coarser chips, and the remaining 50% of the mixture with the coarser chips.

The panel was cured in a press for a total of 5 minutes at an estimated pressure of below about 5·10⁵ Pa (5 bar), under HF heating at a frequency of 27.12 Hz. After 2 minutes cooling down the internal temperature was 160° C..

The resulting article was a panel with a thickness of 20 mm and a smooth and homogenous surface.

### Example 9: Manufacture of Plywood

A plywood sample was manufactured by stacking layers of wood veneer with intermediate layers of the resin composition of Example 1. The veneer layers had a thickness of 1-1.5 mm. 5 layers were used. The total polymer content was about 15 wt. %. The total thickness of the stack was 7 mm.

The stack of layers was cured in a press for a total of 5 minutes at a pressure of 5·10⁵ Pa (5 bar), under HF heating at a frequency of 27.12 Hz. The adhesion properties of the plywood were found to be very good, both under wet conditions and under dry conditions.

1. A method for manufacturing a filler-containing composite object, the method comprising the steps of
providing a composition comprising a filler and a polymer, wherein the polymer is a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, in the range of 0.1-0.8, and
subjecting the composition to a curing step, in which the composition is subjected to high-frequency heating for a period of 10 seconds to 30 minutes, at a pressure of at most 1.10⁶ Pa (10 bar), resulting in the formation of a composite object, wherein high-frequency heating is carried out by subjecting the composition to an alternating electromagnetic field with a frequency in the range of 3-100 MHz.

2. The method according to claim 1, wherein the high-frequency heating is carried out by subjecting the composition to an alternating electromagnetic field with a frequency in the range of 10-50 MHz.

3. The method according to claim 1, wherein high-frequency heating is carried out for a period of 10 seconds to 20 minutes.

4. The method according to claim 1, wherein the curing step is carried out at a pressure of at most 8.10⁵ Pa (8 bar).

5. The method according to claim 1, wherein the composition subjected to the high-frequency curing step has a water content of at least 2 wt. %.

6. The method according to claim 1, wherein the polymer is a polyester derived from an aliphatic polyol with 2-15 carbon atoms and an aliphatic polycarboxylic acid with 3 to 15 carbon atoms, wherein the aliphatic polyol comprises at least 30 wt. % of polyol with at least 3 hydroxyl groups.

7. The method according to claim 1, wherein the polymer having an extent of polymerisation in the range of 0.1 to 0.8 is obtained by subjecting a mixture of polyol and polycarboxylic acid in the liquid phase to a reaction step at a temperature in the range of 20-250° C.

8. The method according to claim 1, wherein the filler is present in an amount of 10-95 wt. %, calculated on the total weight of the composite object.

9. The method according to claim 1, wherein the composite object comprises at least two layers which have the same or different compositions.

10. The method according to claim 1, wherein the composition comprising the filler and the polyester is provided by combining the filler with the polymer when the polymer is in the liquid phase, optionally in the form of an aqueous solution, if so desired followed by one or more of a drying step, a shaping step, or a pre-curing step.

11. The method according to claim 1, preceding claims, wherein the method comprises a shaping step.

12. The method according to claim 1, wherein after curing, the extent of polymerization of the polymer is greater than 0.80, and the water content of the filler-containing composite object is below 10 wt. %, calculated on the total weight of the object.

13. The method according to claim 1, wherein the composite subjected to the curing step has a thickness over the smallest cross section of the object of at least 4 mm.

14. The method according to claim 1, wherein the composition comprising the filler and the polymer further comprises an inorganic salt.

15. The method according to claim 6, wherein the aliphatic polyol with at least 3 hydroxyl groups is at least one of glycerol, the tricarboxylic acid is citric acid, or a combination thereof.

16. The method according to claim 1, wherein at least one of:
the high-frequency heating is carried out by subjecting the composition to an alternating electromagnetic field with a frequency of 13.56 MHz, 27.12 MHz, or 40.68 MHz;
high-frequency heating is carried out for a period of 20 seconds to 10 minutes;
the curing step is carried out at a pressure of at most 6×10⁵ Pa (6 bar), and at least 1.1×10⁵ Pa (1.1 bar);
the composition subjected to the high-frequency curing step has a water content of at least 4 wt. %, and at most 50 wt. %;
the polymer is a polyester derived from an aliphatic polyol with 2-15 carbon atoms and an aliphatic polycarboxylic acid with 3 to 15 carbon atoms, wherein the aliphatic polyol comprises at least 50 wt. %,, and the aliphatic polycarboxylic acid comprises at least 50 wt. % of tricarboxylic acid, calculated on the total amount of acid;
the polymer having an extent of polymerisation in the range of 0.1 to 0.8 is obtained by subjecting a mixture of polyol and polycarboxylic acid in the liquid phase to a reaction step at a temperature in the range of 40-200° C.;
the filler is present in an amount of 20-80 wt. %, calculated on the total weight of the composite object;
after curing, the extent of polymerization of the polymer is greater than 0.90, and the water content of the filler-containing composite object is below 5 wt. %, calculated on the total weight of the object;
the composite subjected to the curing step has a thickness over the smallest cross section of the object of at least 4 mm; or
a combination thereof.

17. The method according to claim 1, wherein at least one of:
the high-frequency heating is carried out by subjecting the composition to an alternating electromagnetic field with a frequency of 27.12 MHz;
high-frequency heating is carried out for a period of 20 seconds to 5 minutes;
the curing step is carried out at a pressure of at most 4·10⁵ Pa (4 bar), and at least 1.1·10⁵ Pa (1.1 bar);
the composition subjected to the high-frequency curing step has a water content of at least 4 wt. %, and at most 20 wt. %;
the polymer is a polyester derived from an aliphatic polyol with 2-15 carbon atoms and an aliphatic polycarboxylic acid with 3 to 15 carbon atoms, wherein the aliphatic polyol comprises at least 70 wt. %, and the aliphatic polycarboxylic acid comprises at least 70 wt. % of tricarboxylic acid, calculated on the total amount of acid;
the polymer having an extent of polymerisation in the range of 0.1 to 0.8 is obtained by subjecting a mixture of polyol and polycarboxylic acid in the liquid phase to a reaction step at a temperature in the range of 60-200° C.;
the filler is present in an amount of 40-70 wt. %, calculated on the total weight of the composite object;
after curing, the extent of polymerization of the polymer is at least 0.95, and the water content of the filler-containing composite object is below 5 wt. %, calculated on the total weight of the object;
the composite subjected to the curing step has a thickness over the smallest cross section of the object of at least 6 mm; or
a combination thereof.

18. The method according to claim 1, wherein at least one of:
high-frequency heating is carried out for a period of 20 seconds to 3 minutes;
the curing step is carried out at a pressure of at most 3·10⁵ Pa (3 bar), and at least 1.1·10⁵ Pa (1.1 bar);
the composition subjected to the high-frequency curing step has a water content of at least 4 wt. %, and at most 15 wt. %;
the polymer is a polyester derived from an aliphatic polyol with 2-15 carbon atoms and an aliphatic polycarboxylic acid with 3 to 15 carbon atoms, wherein the aliphatic polyol comprises at least 90 wt. %, and the aliphatic polycarboxylic acid comprises at least 90 wt. % of tricarboxylic acid, calculated on the total amount of acid;
the polymer having an extent of polymerisation in the range of 0.1 to 0.8 is obtained by subjecting a mixture of polyol and polycarboxylic acid in the liquid phase to a reaction step at a temperature in the range of 90-200° C.;
after curing, the extent of polymerization of the polymer is at least 0.98, and the water content of the filler-containing composite object is below 5 wt. %, calculated on the total weight of the object;
the composite subjected to the curing step has a thickness over the smallest cross section of the object of at least 8 mm; or
a combination thereof.

19. The method according to claim 1, wherein at least one of:
the curing step is carried out at a pressure of at most 6·10⁵ Pa (6 bar), and at least 1.5. 105 Pa (1.5 bar);
the composition subjected to the high-frequency curing step has a water content of at least 4 wt. %, and at most 11 wt. %;
the polymer is a polyester derived from an aliphatic polyol with 2-15 carbon atoms and an aliphatic polycarboxylic acid with 3 to 15 carbon atoms, wherein the aliphatic polyol comprises 95 wt. %, and the aliphatic polycarboxylic acid comprises 95 wt. % of tricarboxylic acid, calculated on the total amount of acid;
after curing, the extent of polymerization of the polymer is greater than 0.90, and the water content of the filler-containing composite object is below 2 wt. %, calculated on the total weight of the object;
the composite subjected to the curing step has a thickness over the smallest cross section of the object of at least 10 mm; or
a combination thereof.

20. The method according to claim 1, wherein at least one of:
the curing step is carried out at a pressure of at most 4·10⁵ Pa (4 bar), and at least 1.5·10⁵ Pa (1.5 bar);
after curing, the extent of polymerization of the polymer is greater than 0.90, and the water content of the filler-containing composite object is below 1 wt. %, calculated on the total weight of the object;
the composite subjected to the curing step has a thickness over the smallest cross section of the object of at least 15 mm; or
a combination thereof.
